(19) United States
(12) Patent Application Publication
(10) Pub. No.: US 2016/0088439 A1
(43) Pub. Date: Mar. 24, 2016

(54) METHOD AND APPARATUS FOR CONTROLLING OPERATION OF A SYSTEM

(71) Applicant: Nokia Technologies Oy, Espoo (FI)

(72) Inventors: Miikka Vilermo, Siuro (FI); Matti Hamalainen, Lempaala (FI); Roope Jarvinen, Lempaala (FI); Sampo Vesa, Helsinki (FI)

(21) Appl. No.: 14/891,520

(22) PCT Filed: Jun. 5, 2013
(86) PCT No.: PCT/FI2013/050606

§ 371 Date: Nov. 16, 2015

(51) Int. Cl. H04W 4/02

(52) U.S. Cl. CPC H04W 4/023; H04W 84/18

(57) ABSTRACT

The invention relates to controlling the operation of a communication system. The method according to the invention comprises measuring (910) positions of devices of a group; determining (930) a sequence based on the measured positions; and controlling (940) operation of one or more devices of a group based on said sequence. The communication system may be used e.g. for playing games.

### FIELD

Several embodiments relate to controlling operation of a system.

### BACKGROUND

A communication system may comprise two or more portable devices, which may be configured to communicate with each other. The system may be used e.g. for playing games.

### SUMMARY

Some variations may relate to controlling operation of a system. Some variations may relate to controlling timing of tasks performed by a system. Some variations may relate to a system, which is configured to control operation of said system.

Some variations may relate to a device, which is configured to operate as a part of a system. Some variations may relate to a computer program for controlling operation of a system. Some variations may relate to a computer program product comprising a computer program for controlling operation of a system.

According to a first aspect, there is provided a method comprising:
measuring positions of devices of a group,
determining a sequence based on the measured positions, and
controlling operation of one or more devices of a group based on said sequence.

According to a second aspect, there is provided an apparatus comprising at least one processor, a memory including computer program code, the memory and the computer program code configured to, with the at least one processor, cause the apparatus to perform at least the following:
obtain positions of devices of a group,
determine a sequence based on the obtained positions, and
control operation of one or more devices of a group based on said sequence.

According to a third aspect, there is provided a computer program comprising computer program code configured to, when executed on at least one processor, cause an apparatus or a system to:
measure positions of devices of a group,
determine a sequence based on the measured positions, and
control operation of one or more devices of a group based on said sequence.

According to a fourth aspect, there is provided a computer program product embodied on a non-transitory computer readable medium, comprising computer program code configured to, when executed on at least one processor, cause an apparatus or a system to:
measure positions of devices of a group,
determine a sequence based on the measured positions, and
control operation of one or more devices of a group based on said sequence.

According to a fifth aspect, there is provided a means for communicating, the means for communicating comprising:
means for measuring positions of devices of a group,
means for determining a sequence based on the measured positions, and
means for controlling operation of one or more devices of a group based on said sequence.

A communication system may comprise several portable devices, which may be configured to communicate with each other according to an order, which depends on the relative positions of the devices. For example, the communication system may be configured to enable sending a message from a portable device of a first person to a portable device of a second person only when the portable device of a third person is not located between the first person and the second person. The operation of the system may be controlled based on measured relative positions of the devices. The operation of the system may be controlled based on a sequence, which specifies an order of identifiers in a set of identifiers. The operation of an individual device of the system may be controlled based on the sequence. The sequence may be called e.g. as a control sequence. The sequence may specify an ordered list of identifiers. The sequence may be defined e.g. by providing a list of identifiers (e.g. [7,8,9,6,2,5,3,4,1] or [ID7, ID8, ID9, ID6, ID2, ID5, ID3, ID4, ID1]). The sequence may be defined e.g. by providing a graph (see e.g. FIG. 3a). The sequence may be defined e.g. by providing an function (e.g. an identifier function q(p), where the integer p may be monotonously increased from 1 to m. m may denote the number of separately movable devices of the communication system.

The communication system may be configured to provide e.g. a platform for obtaining user input in a controlled manner. The communication system may be configured to provide e.g. a platform for making selections, wherein the options available for the selection may depend on the relative positions of the devices. The communication system may be configured to provide e.g. a platform for providing feedback related to one or more adjacent persons.

The communication system may be configured to provide e.g. a platform for playing games. The communication system may be configured to provide e.g. a platform for displaying information. The communication system may also be configured to provide e.g. a platform for audio playback.

A group of portable devices may form a communication network. The control sequence may be determined based on the actual measured positions of the devices. The control sequence may be determined from the actual measured positions of the devices by a mapping operation. The actual measured positions of the devices may be mapped into the control sequence. The control sequence may be considered to represent the quantized relative positions of the devices.

Transfer of data to and from portable devices at different arbitrary locations may be controlled according to the control sequence. For example, the control sequence may comprise a first identifier ID1 representing a first device, a second identifier ID2 representing the second device, and a third identifier ID3 representing a third device, wherein transfer of data from the first device to a second device may be allowed only when the second identifier ID2 is adjacent to the first identifier ID1 in the control sequence. Transfer of data from the first device to a second device may be prevented e.g. when the third identifier ID3 is located between the first identifier ID1 and the second identifier ID2 in the control sequence. For example, transfer of data from the first device to a second device may be enabled when the control sequence contains identifiers in the following order . . . ID1, ID2, ID3 . . . . For example, transfer of data from the first device to a second device may be disabled when the control sequence contains identifiers in the following order . . . ID1, ID3, ID2 . . . .

The number of devices of said group may be changed dynamically, i.e. one or more devices may be added to the group or removed from said group. The devices may be carried by users. The users of the devices may move the devices with respect to each other.

In an embodiment, the control sequence may be determined based on the relative positions of the devices in an initial situation. In an embodiment, the control sequence may be substantially continuously modified to match with an ad hoc group of portable devices.

A group of portable devices may form a communication network. The communication network formed by the devices may also be represented by a communication graph. Said graph may specify the control sequence for controlling operation of the system. The graph may comprise nodes, which may be associated with the identifiers of the devices. The nodes of the graph may be connected by links. The nodes may also be called as vertices, and the links may also be called as edges.

For example, transfer of data from first device represented by a first node to a second device represented by a second node may be allowed only if the second node is connected to the first node by a link. Transfer of data from the first device to the second device may be prevented if the second node is not connected to the first node by a link.

For example, a first device may be represented by a first node, a second device may be represented by a second node, and a third device may be represented by a third node such that the first node is connected to a second node by a link, the second node is connected to the third node by a link, and the first node is not directly connected to the third node. In this case, the system may be configured to operate such that a command received from the second device is executed only between executing a command received from the first device and executing a command received from the third device. In an embodiment, the command received from the second device may be ignored if it is received before receiving the command from the first device. In an embodiment, executing the command from the third device may be enabled only after the command has been received from the second device.

In an embodiment, a communication graph may be determined based on the relative positions of the devices in an initial situation. In an embodiment, a communication graph may be substantially continuously matched with an ad hoc group of portable devices.

In an embodiment, communication may be carried out in an order, which is determined substantially in real time based on analysis of sounds received by microphones. In an embodiment, the location and/or orientation of the portable devices may be determined by analyzing sounds received by microphones of the portable devices. In an embodiment, the sounds may be ambient sounds, which may be generated e.g. when people are speaking, walking, coughing or tapping a touch screen. In an embodiment, the sounds may also be generated by the portable devices themselves.

Controlling the communication according to the relative positions of the devices may e.g. enhance a social aspect associated with the communication.

### BRIEF DESCRIPTION OF THE DRAWINGS

In the following examples, several variations will be described in more detail with reference to the appended drawings, in which

FIG. 1a shows, by way of example, spatial positions of portable devices of a group,

FIG. 1b shows, by way of example, spatial positions of portable devices of a group,

FIG. 2a shows, by way of example, comparing the spatial positions with an elliptical reference curve,

FIG. 2b shows, by way of example, comparing the spatial positions with a reference line,

FIG. 2c shows, by way of example, distances between pairs of devices,

FIG. 2d shows, by way of example, projected distances between pairs of devices,

FIG. 3a shows, by way of example, a circular graph representing the spatial positions of FIG. 1a,

FIG. 3b shows, by way of example, a circular graph representing the spatial positions of FIG. 1b,

FIG. 4a shows, by way of example, a linear graph representing the spatial positions of FIG. 1a,

FIG. 4b shows, by way of example, a linear graph representing the spatial positions of FIG. 1b,

FIG. 4c shows, by way of example, a graph representing the spatial positions of FIG. 1a,

FIG. 4d shows, by way of example, a graph representing the spatial positions of FIG. 1a,

FIG. 4e shows, by way of example, a graph representing the spatial positions of FIG. 1a,

FIG. 4f shows, by way of example, a grid graph representing the spatial positions of FIG. 1a,

FIG. 5a shows, by way of example, timing of tasks,

FIG. 5b shows, by way of example, timing of tasks,

FIG. 5c shows, by way of example, timing of tasks,

FIG. 5d shows, by way of example, method steps for controlling operation of a system,

FIG. 6 shows, by way of example, functional units of a portable device,

FIG. 7 shows, by way of example, a set-up for determining the relative position of a second microphone with respect to the position of a first microphone,

FIG. 8a shows, by way of example, functional units of a portable device,

FIG. 8b shows, by way of example, functional units of a portable device,

FIG. 9 shows, by way of example, functional units of a portable imaging device,

FIG. 10a shows, by way of example, a communication system,

FIG. 10b shows, by way of example, a portable device, and

FIG. 10c shows, by way of example, a server.

### DETAILED DESCRIPTION

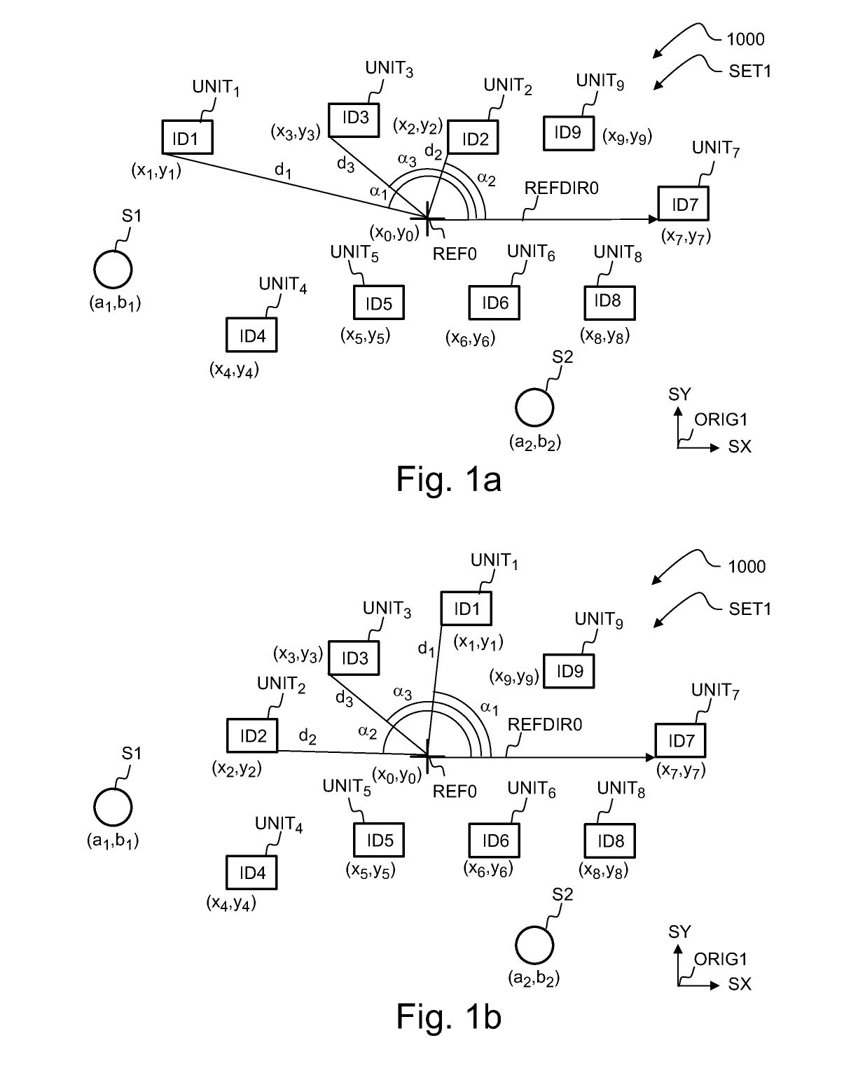

Referring to FIG. 1a, a system 1000 may comprise a group SET1 of portable devices UNIT₂, UNIT₃, . . . . The group SET1 may comprise e.g. three or more individually movable portable devices UNIT₁, UNIT₂, UNIT₃. The devices UNIT₁, UNIT₂, . . . may have different positions (x₁,y₁), (x₂,y₂), . . . in a coordinate system defined by the directions SX, SY, SZ. The coordinate system may have an origin ORIG1. The coordinate system may be called e.g. as the “real space”.

The devices UNIT₁, UNIT₂, UNIT₃ may be used by users, which may be located in the vicinity of their devices. The devices UNIT_{q} may be e.g. smartphones, which may be configured to communicate with each other. In an embodiment, each device UNIT_{q} may be carried by a different user.

The devices UNIT₁, UNIT₂, UNIT₃, . . . may form a group SET1 of devices. The group SET1 may comprise e.g. three or more devices UNIT₁, UNIT₂, UNIT₃, . . . The group SET1 may comprise e.g. five or more devices UNIT₁, UNIT₂, UNIT₃. The number of devices UNIT₁, UNIT₂, UNIT₃ of the group SET1 may be e.g. in the range of 3 to 100. The number of devices UNIT₁, UNIT₂, UNIT₃ of the group SET1 may be e.g. in the range of 10 to 100.

Each device UNIT₁, UNIT₂, UNIT₃ may have a different identity, which may be specified by an identifier q. Each device UNIT_{q} may be identified by an identifier q. The identifier q may be e.g. an identifier index, wherein the identifier q may have e.g. an integer value 1, 2, 3, . . . The identifier q may have e.g. an integer value selected from the range of 1 to m. m denotes the number of the units UNIT_{q} belonging to the group SET1. Each device UNIT_{q} may have a different identifier q.

The symbol UNIT_{q} may refer to a device specified by an identifier q. Each device UNIT₁, UNIT₂, UNIT₃ may also be optionally specified by an identifier code ID1, ID2, ID3, . . . Each unit UNIT_{q} may also have an identifier code IDq. In an embodiment, the identifier code IDq may be equal to the identifier index q. However, the identifier code IDq may also be e.g. a telephone number or the name of the user. The identifier code IDq of a device UNIT_{q} may be equal to the identifier q of said device (i.e. IDq=q), or the identifier code IDq of the device UNIT_{q} may be different from the identifier q of said device (i.e. IDq≠q).

One or more reference points REF0 may be determined based on the positions of the devices. The positions (x₁,y₁), (x₂,y₂), . . . of the devices UNIT₁, UNIT₂, . . . may be determined with respect to a reference point REF0 at the position (x₀,y₀). The reference point REF0 may e.g. coincide with the position of a device or with an average position of all devices of the group SET1. The average position may also be called e.g. as the “center of gravity” of the devices. In particular, the position (x₀,y₀) of the center of gravity REF0 of the devices may be determined from the relative positions of the devices. The position of each device may be defined with respect to the position (x₀,y₀) of the center of gravity REF0. The position of each device UNIT_{q} may be specified e.g. by lateral coordinates x_{q}, y_{q}, and/or by an angular coordinate α_{q} and a distance d_{q}. The angular position of a device UNIT_{q} may be specified e.g. by the angular coordinate α_{q}.

The position (x_{q},y_{q}) of each device UNIT_{q} with respect to the reference position (x₀,y₀) may be defined by providing an angular coordinate α_{q} and a distance d_{q}. The relative position (x₁-x₀,y₁-y₀) of the first device UNIT₁ with respect to the reference point REF0 may be expressed by providing an angular coordinate α₁ and a distance d₁. The angular coordinate α₁ may be defined e.g. with respect to a reference direction REFDIR0. The reference direction REFDIR0 may be defined e.g. by the reference point REF0 and a predetermined device (e.g. the device UNIT₇). The relative position (x₂-x₀,y₂-y₀) of the second device UNIT₂ with respect to the reference point REF0 may be expressed by providing an angular coordinate α₂ and a distance d₂. The relative position (x₃-x₀,y₃-y₀) of the third device UNIT₃ with respect to the center of gravity REF0 may be expressed by providing an angular coordinate α₃ and a distance d₃.

The spatial position of a first device UNIT₁ having an identifier q=1 may be defined by an angular coordinate α₁, the position of a second device UNIT₂ having an identifier q=2 may be defined by an angular coordinate α₂, and a third device UNIT₃ having an identifier q=3 may be defined by an angular coordinate α₃. The spatial position of a device UNIT_{q} having an identifier q may be defined by an angular coordinate α_{q}.

The positions (x₁,Y₁), (x₂,y₂), . . . of the devices UNIT₁, UNIT₂, . . . may be measured e.g. based on propagation of radio waves. For example, the devices may send and/or receive radio waves, wherein the distances between the devices may be determined from propagation delays of the radio waves and/or from attenuation of the radio waves.

In an embodiment, the positions (x₁,y₁), (x₂,y₂), . . . of the devices UNIT₁, UNIT₂, may be measured e.g. analyzing sound waves emitted from two or more sound sources S1, S2. The relative positions of the devices of the group SET1 may be at least approximately determined by analyzing the sounds SW1, SW2. For example, a first sound SW1 may be emitted from a first sound source S1, and a second sound SW2 may be emitted from a second sound source S2.

The relative position (x₂-x₁,y₂-y₁) of a second device UNIT₂ with respect to a first device UNIT₁ may be at least approximately determined by analyzing two or more sounds SW1, SW2 emitted from two or more different positions (a₁,b₁), (a₂,b₂). A first sound source S1 may be at the position (a₁,b₁), and a second sound source S2 may be at the (different) position (a₂,b₂). The sound sources S1, S2 may be e.g. persons, which are speaking or making other sounds e.g. by tapping a touch screen with a finger or by coughing. Each device UNIT₁, UNIT₂ may comprise one or more microphones for monitoring the sounds SW1, SW2.

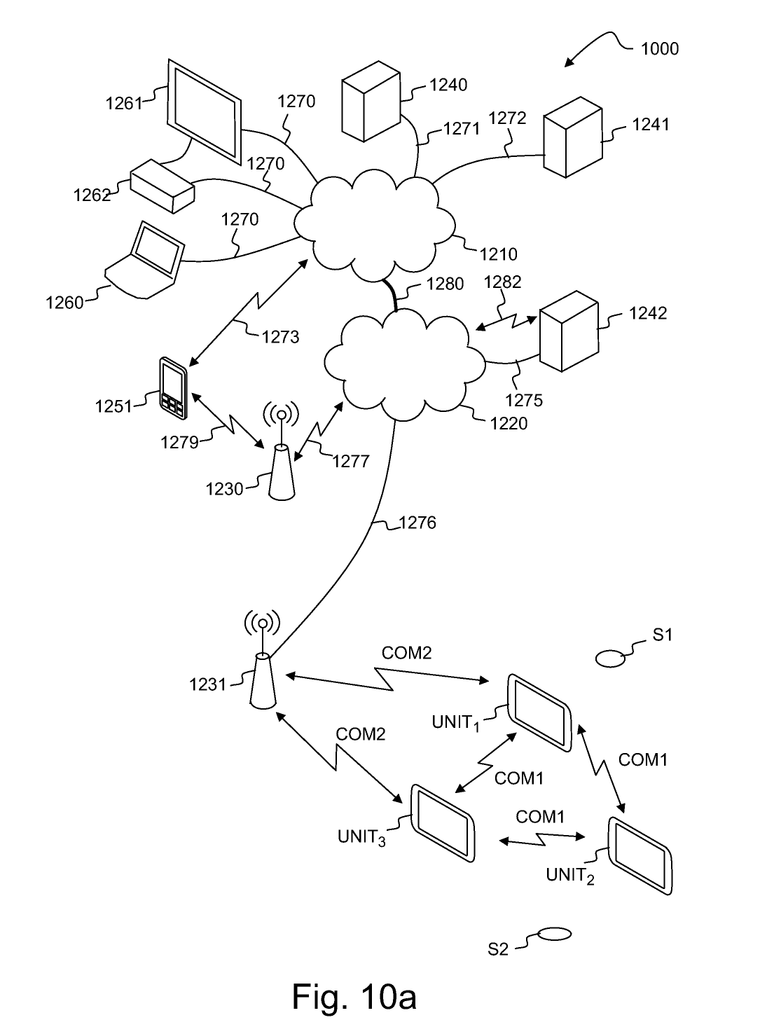

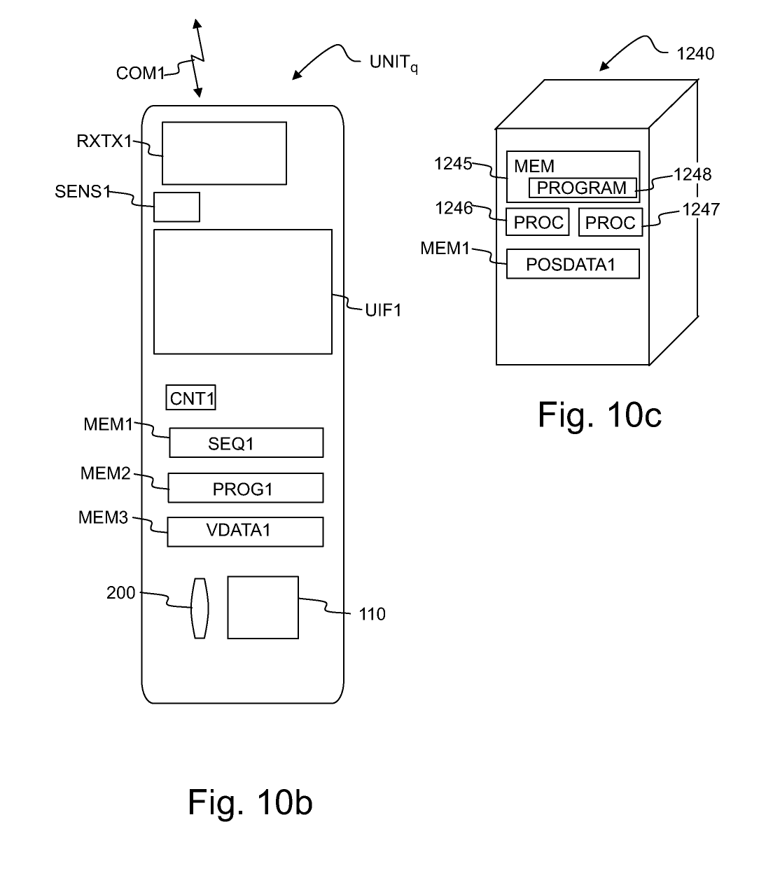

The system 1000 may optionally comprise devices which do not belong to the group SET1 and/or which are not portable (see e.g. FIG. 10a or 10c). The vertical direction SZ is perpendicular to the horizontal directions SX and SY. The directions SX, SY, SZ are orthogonal.

Referring to FIG. 1b, the portable devices UNIT₁, UNIT₂, UNIT₃ may be moved with respect to each other. For example, the users carrying the devices may be moving with respect to each other. Each portable device may be carried by a different user. The users of the devices may move the devices with respect to each other.

For example, a second device UNIT₂ may be moved with respect to a first device UNIT₁. A third device UNIT₃ may be moved with respect to the first device UNIT₁. One or more of the devices UNIT₁, UNIT₂ may be moved with respect to the reference point REF0. Each device may be moved with respect to the reference point REF0.

The operation of the system 1000 may be controlled based on the control sequence SEQ1. The control sequence SEQ1 may define an ordered list of terms, wherein each term may represent an identifier of a different device UNIT₁, UNIT₂, UNIT₃. For example, the control sequence SEQ1 may be represented by an ordered list [7,8,9,6,2,5,3,4,1].

The control sequence SEQ1 may be optionally updated according to the relative positions of the devices. The control sequence SEQ1 may be updated substantially in real time according to the relative positions of the devices.

The devices UNIT_{q} of a system 1000 may have first positions during a first time period, and the devices UNIT_{q} may have second positions during a second time period. A first control sequence may be determined from the first positions, and a second control sequence may be determined from the second positions, wherein the second control sequence may be different from the first control sequence. The operation of the system 1000 may be controlled based on the first control sequence during said first time period, and the operation of the system 1000 may be controlled based on the second control sequence during said second time period.

In an embodiment, a control sequence SEQ1 determining during a first time period (e.g. during an initial time period) may be applied even if the relative positions of the devices would be changed.

The type of the control sequence may be e.g. linear or circular. A circular sequence is a sequence whose first and last term are considered adjacent.

In an embodiment, the type of the control sequence may be determined based on application.

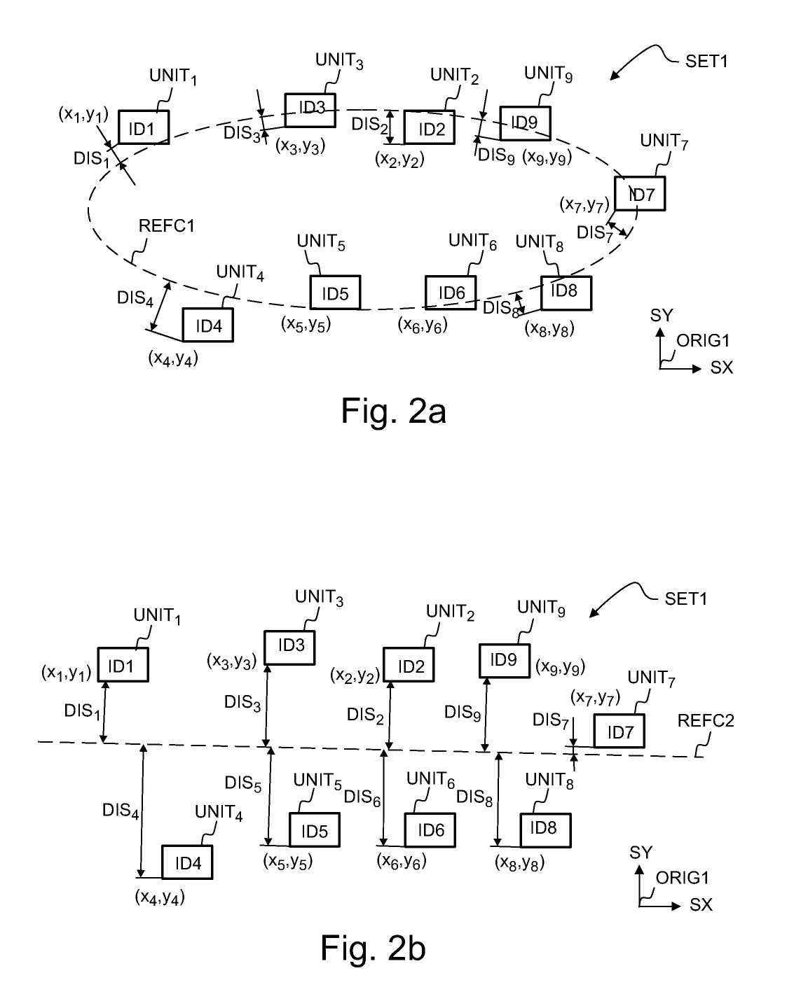

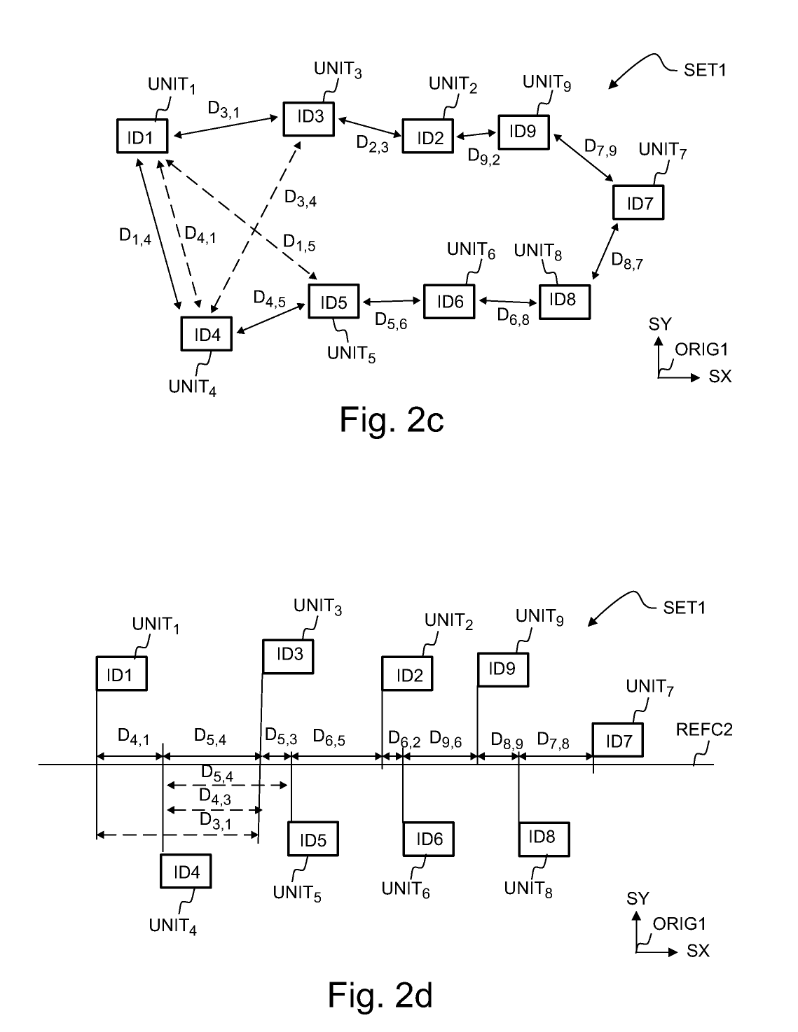

Referring to FIGS. 2a and 2b, the type of the control sequence may be determined based on the measured positions of the devices UNIT₁, UNIT₂, UNIT₃, . . . The control sequence may be determined to be circular e.g. when the positions of the devices UNIT₁, UNIT₂, UNIT₃ substantially match with an elliptical reference curve REFC1. A circle may also be considered to be an elliptical curve. The control sequence may be determined to be linear e.g. when the positions of the devices UNIT₁, UNIT₂, UNIT₃ substantially match with a linear reference curve REFC2. The linear reference curve REFC2 may be a line.

The type of the control sequence may be determined based on the measured positions x_{q},y_{q} of the devices UNIT_{q}. The type of the control sequence may be determined by comparing the positions (x_{q},y_{q}) with a first reference curve REFC1 and a second reference curve REFC2. The type of the control sequence may be determined by determining which reference curve REFC1, REFC1 provides best match with the positions (x_{q},y_{q}).

The method may comprise determining the distances DIS_{q} of the devices UNIT_{q} from a reference curve REFC1, REFC2.

The method may comprise determining the type of the control sequence SEQ1 based on the distances DIS_{q} of the devices UNIT_{q} from a reference curve REFC1. The method may comprise determining the sum of the distances DIS_{q}. The method may comprise determining the root means square (RMS) value the distances DIS_{q}. The type of the control sequence may be determined by determining which reference curve REFC1, REFC1 provides a minimum value of the sum. The type of the control sequence may be determined by determining which reference curve REFC1, REFC1 provides a minimum RMS distance.

Referring to FIG. 2c, the control sequence SEQ1 may be determined based on a sum of distances D_{p,p+1} between pairs of devices, wherein said pairs are formed such that the first device and the second device of each pair correspond to adjacent elements of said sequence. The control sequence SEQ1 may be determined based on the positions (x₁,y₁), (x₂,y₂), . . . of the devices UNIT₁, UNIT₂, . . . such that the sum of distances D_{7,9}, D_{9,2}, D_{2,3}, . . . between pairs of the devices is minimized, wherein said pairs are formed such that the first device and the second device of each pair correspond to adjacent elements of the control sequence SEQ1. The distance D_{p,p+1} between a first device and a second device of a pair may also be called e.g. as a pairwise distance. The distance D_{p,p+1} may denote the distance between a device UNIT_{q(p)} and a device UNIT_{q(p+1}), wherein the order number p may have values from 1 to m−1.

A first candidate SEQ1 for a circular control sequence may be e.g. [7,9,2,3,1,4,5,6,8], and a second candidate SEQ1′ for a circular control sequence may be e.g. [7,9,2,3,4,1,5,6,8]. In this example, the second candidate SEQ1′ may be obtained from the first candidate SEQ1 by interchanging the positions of the identifiers 4 and 1 associated with the devices UNIT₄ and UNIT₁.

The pairs corresponding to the adjacent elements of the first candidate SEQ1 are (UNIT₇,UNIT₉), (UNIT₉,UNIT₂), (UNIT₂,UNIT₃), (UNIT₃,UNIT₁), (UNIT₁,UNIT₄), (UNIT₄,UNIT₅), (UNIT₅,UNIT₆), (UNIT₆,UNIT₈), (UNIT₈, UNIT₉). The sum D_{7,9}+D_{9,2}+D_{2,3}+D_{3,1}+D_{1,4}+D_{4,5}+D_{5,6}+D_{6,8}+D_{8,7} of the distances between said pairs is equal to a first sum value SUM1.

The pairs corresponding to the adjacent elements of the second candidate SEQ1′ are (UNIT₇,UNIT₉), (UNIT₉,UNIT₂), (UNIT₂,UNIT₃), (UNIT₃,UNIT₄), (UNIT₄,UNIT₁), (UNIT₁,UNIT₅), (UNIT₅,UNIT₆), (UNIT₆,UNIT₈), (UNIT₈, UNIT₉). The sum D_{7,9}+D_{9,2}+D_{2,3}+D_{3,4}+D_{4,1}+D_{1,5}+D_{5,6}+D_{6,8}+D_{8,7} of the distances between said pairs is equal to a second sum value SUM1′.

It may be noticed that the first sum value SUM1 is smaller than the second sum value SUM1′. Thus, forming the pairs according to the first candidate sequence SEQ1 may minimize the sum of the pairwise distances when compared to forming the pairs according to the second candidate sequence SEQ1′.

Further candidate sequences may be provided e.g. by permutation of the terms (i.e. indices) of the previous candidate sequences. The order to the terms may be permutated until the sum of the pairwise distances is minimized to a sufficient degree. That candidate sequence, which provides the minimum sum, may be used for controlling operation of the system 1000.

Referring to FIG. 2d, the pairwise distances may also be projected on a reference line REFC2. The control sequence SEQ1 may be determined based on a sum of projected distances D_{p,p+1} between pairs of devices, wherein said pairs are formed such that the first device and the second device of each pair correspond to adjacent elements of said sequence.

The control sequence SEQ1 may be determined based on the positions (x₁,y₁), (x₂,y₂), . . . of the devices UNIT₁, UNIT₂, . . . such that the sum of the projected distances D_{7,8}, D_{8,9}, D_{9,8}, . . . between pairs of the devices is minimized, wherein said pairs are formed such that the first device and the second device of each pair correspond to adjacent elements of the control sequence SEQ1.

A first candidate SEQ1 for a control sequence may be e.g. [7,8,9,6,2,5,3,4,1], and a second candidate SEQ1′ for a control sequence may be e.g. [7,8,9,6,2,5,4,3,1]. In this example, the second candidate SEQ1′ may be obtained from the first candidate SEQ1 by interchanging the positions of the identifiers 4 and 3 associated with the devices UNIT₄ and UNIT₅.

The pairs corresponding to the adjacent elements of the first candidate SEQ1 are (UNIT₇,UNIT₈), (UNIT₈,UNIT₉), (UNIT₉,UNIT₆), (UNIT₆,UNIT₂), (UNIT₂,UNIT₅), (UNIT₅,UNIT₃), (UNIT₃,UNIT₄), (UNIT₄,UNIT₁). The sum D_{7,8}+D_{8,9}+D_{9,6}+D_{6,2}+D_{2,5}+D_{5,3}+D_{3,4}+D_{4,1} of the distances between said pairs is equal to a first sum value SUM1.

The pairs corresponding to the adjacent elements of the second candidate SEQ1′ are (UNIT₇,UNIT₈), (UNIT₈,UNIT₉), (UNIT₉,UNIT₆), (UNIT₆,UNIT₂), (UNIT₂,UNIT₅), (UNIT₅,UNIT₃), (UNIT₃,UNIT₄), (UNIT₄,UNIT₁). The sum D_{7,8}+D_{8,9}+D_{9,8}+D_{6,2}+D_{2,5}+D_{5,4}+D_{4,3}+D_{3,1} of the distances between said pairs is equal to a second sum value SUM2.

It may be noticed that the first sum value SUM1 is smaller than the second sum value SUM1′. Thus, forming the pairs according to the first candidate sequence SEQ1 may minimize the sum of the pairwise distances when compared to forming the pairs according to the second candidate sequence SEQ1′.

The actual (real) position of each unit UNIT_{q} may be specified e.g. by an angular coordinate α_{q} and/or by a linear coordinate x_{q} (or y_{q}).

A control sequence SEQ1 may also be determined e.g. by sorting coordinates of the devices in an ascending or descending order. For example, the lateral coordinates x_{q} may be sorted, the lateral coordinates y_{q} may be sorted, or the angular coordinates α_{q} may be sorted.

Determining the control sequence SEQ1 may comprise:
determining one or more coordinates α_{q} for each device UNIT_{q} of the group SET1 based on the measured positions x_{q},y_{q}, and
determining the sequence SEQ1 by sorting said coordinates α_{q}.

A control sequence SEQ1 may be determined by sorting angular coordinates α_{q}. In particular, a cyclic control sequence SEQ1 may be determined by sorting angular coordinates α_{q}.

An output matrix M2 may be generated from an input matrix M1 by sorting coordinates of an input matrix M1. A first column (or row) of the input matrix M1 may contain the coordinates α_{q} in an arbitrary order. A second column (or row) of the input matrix M1 may contain the identifiers q such that each row (or column) of the input matrix M1 contains a coordinate α_{q} and an identifier q of a unit. A first column (or row) of the output matrix M2 may comprise the coordinates α_{q} arranged in increasing or decreasing order. A second column (or row) of the output matrix M2 may contain the identifier indices q such that each row (or column) of the output matrix M2 contains a coordinate α_{q} and an identifier index q of a unit.

TABLE 1
An example of an input matrix M1

| Coordinate | Identifier |
|---|---|
| α_{q} | q |
| α₄ | 4 |
| α₁ | 1 |
| α₃ | 3 |
| α₅ | 5 |
| α₂ | 2 |
| α₆ | 6 |
| α₉ | 9 |
| α₈ | 8 |
| α₇ | 7 |

TABLE 2
An example of an output matrix M2

| Coordinate | Identifier |
|---|---|
| α_{q} | q |
| α₇ | 7 |
| α₉ | 9 |
| α₂ | 2 |
| α₃ | 3 |
| α₁ | 1 |
| α₄ | 4 |
| α₅ | 5 |
| α₆ | 6 |
| α₈ | 8 |

The second column of the output matrix M2 may be used as the control sequence SEQ1.

The output matrix M2 may be generated from the input matrix M1 by one or more processors. The output matrix M2 may be provided e.g. by using a sorting function SRT, i.e. M2=SRT(M1). The sorting function SRT may be implemented e.g. by executing computer program code by one or more processors.

Each unit UNIT_{q} may be associated with an order number p. The order number p associated with an identifier q may indicate the position of said identifier q in the control sequence SEQ1. The order number p may have e.g. an integer value selected from the range of 1 to m. The order number p may be expressed as a function p(q) of the identifier q. The function p(q) may be called e.g. as an order number function. The order number function p(q) may provide the position p of each identifier q in the control sequence SEQ1.

The order number p may also represent the quantized position of the unit UNIT_{q} in the group SET1. The order number p may also be called as the position index.

The values of the order number function p(q) may be determined e.g. from the output matrix M2 or from the control sequence SEQ1.

The identifier value q at each position p of the control sequence SEQ1 may be expressed as an identifier function q(p), where the position value p may have values from 1 to m. The control sequence SEQ may comprise or consist of the following sequence: q(1), q(2), q(3), q(4), . . . q(m). The integer m may denote the number of devices UNITₘ UNIT₂, . . . of the group SET1. For example, when p=1, the identifier function q(p) may provide the value q(1) of the identifier at the first position of the sequence SEQ1, and when p=2, identifier function q(p) may provide the value q(2) of the identifier at the second position of the sequence SEQ1. For example, when the control sequence SEQ1 is [7,8,9,6,2,5,3,4,1], the identifier function q(p) may give the following identifiers q as the function of the order number p: q(1)=7, q(2)=8, q(3)=9, q(4)=6, q(5)=2, q(6)=5, q(7)=3, q(8)=4, q(9)=1.

The input matrix M1 may comprise a list LIST1 of coordinates α_{q}. The output matric M2 may comprise a sorted list LIST2 of coordinates α_{q}

The identifier function q(p) may be determined e.g. by:
providing a list LIST1 of coordinates α_{q} by measuring the position coordinate α_{q} for each unit UNIT_{q} belonging to the group SET1, wherein each unit UNIT_{q} has a different identifier q,
providing a sorted list LIST2 of coordinates α_{q} by sorting the coordinates according to the increasing order of magnitude, and
determining the identifier function q(p) such that α_{q(p)}<α_{q(p+1)} for all values of p from 1 to m−1.

The order number function p(q) may be determined e.g. by:
providing a list LIST1 of coordinates α_{q} by measuring the position coordinate α_{q} for each unit UNIT_{q} belonging to the group SET1, wherein each unit UNIT_{q} has a different identifier q,
providing a sorted list LIST2 of coordinates α_{q} by sorting the coordinates according to the increasing order of magnitude, and
determining the order number function p(q) from the position of each coordinate α_{q} in the sorted list LIST2.

The coordinates α_{q} may be arranged e.g. according to increasing order such that α_{q(p)}<α_{q(p+1)} for all values of p from 1 to m−1. The order number p may denote the position of an identifier in the control sequence SEQ1. The order number p may specify the quantized position of a unit UNIT_{q(p)}.

The order number function p(q) may also be determined e.g. as an inverse function of the identifier function q(p).

The devices UNIT_{q} may form a group SET1, wherein each device UNIT_{q} may be associated with a task TASK_{q}. A task TASK_{q} may comprise e.g. receiving user input via a user interface of a device UNIT_{q}, and/or displaying information by the user interface of a device UNIT_{q}. A series of tasks TASK_{q} may be performed in a certain order. The TASK_{q} may be performed in an order determined by the control sequence SEQ1. For example, a second task associated with a second device may be started only after a first task associated with a first device has been finished. For example, the state of a system may be changed according to a first user input received from a first device, and the state of a system may be changed according to a second user input received from a second device. The devices of the group SET1 may be configured to operate such that the second user input is not taken into consideration before the first user input is received.

A task TASK_{q} may denote a task, which is performed by using a unit UNIT_{q}, which is associated with an identifier index q. The tasks TASK_{q} may be performed consecutively in an order, which is defined by the control sequence SEQ1. For example, when the control sequence SEQ1 contains the identifiers q in the following order: [7,8,9,6,2,5,3,4,1], the tasks TASK_{q} may be performed in the following order: TASK₇, TASK₈, TASK₉, TASK₆, TASK₂, TASK₅, TASK₃, TASK₄, TASK₁.

The control sequence SEQ1 may be defined by the identifier function q(p). The timing of the tasks TASK_{q} may be determined according to a control sequence SEQ1, which is defined by the identifier function q(p).

A task TASK_{q(p+1)} may be started (or performed) later than a task TASK_{q(p)} for all values of p from 1 to m−1. A task TASK_{q(p)} may be started between starting a task TASK_{q(p-1)} and starting a task TASK_{q(p+1)} for all values of p from 2 to m−1.

Depending on the application, the tasks TASK_{q} may be performed e.g. in a linear order or in a cyclic order.

Performing the tasks in cyclic order may mean that a sequence of tasks may be repeated several times, wherein the sequence of tasks is defined by the control sequence SEQ1. Performing the tasks in cyclic order may mean that the tasks may be performed according to the control sequence SEQ1 for a second time after the tasks have been performed according to the control sequence SEQ1 for a first time. Performing the tasks in cyclic order may mean that the tasks TASK_{q} may be performed according to the control sequence SEQ1 after a task TASK_{q(m)} indicated by the control sequence SEQ1 has been performed.

The timing of the tasks TASK_{q(p)} may be determined according to the identifier index function q(p) such that a task TASK_{q(p+1)} is started (or performed) later than a task TASK_{q(p)} for all values of p from 1 to m−1, wherein the identifier function q(p) has been determined based on a sorted list of position coordinates α_{q} such that α_{q(p)}<α_{q(p+1)} for all values of p from 1 to m−1.

The timing of the tasks TASK_{q(p)} may be determined according to the sorted list LIST2 such that a task TASK_{q(p+1)} is performed later than a task TASK_{q(p)} for all values of p from 1 to m−1. The tasks TASK_{q(p)} may be performed in an order determined by the sorted list LIST2. The tasks TASK_{q} may be performed in an order determined by the identifier function q(p). The tasks TASK_{q} may be performed according to the order number function p(q). The tasks TASK_{q} may be performed in an order determined by the order number function p(q).

The tasks TASK_{q} may be performed in an order, which is determined based on the actual positions (x_{q},y_{q}) of the devices UNIT_{q}. The tasks TASK_{q} may be performed in an order, which is determined based on the measured position coordinates of the devices UNIT_{q}. The tasks TASK_{q} may be performed in an order, which is determined based on the measured angular position coordinates α_{q} of the devices UNIT_{q}. The tasks TASK_{q} may be performed in an order, which is defined by a control sequence SEQ1, wherein the control sequence may be determined based on the positions (x_{q},y_{q}) of the devices UNIT_{q}.

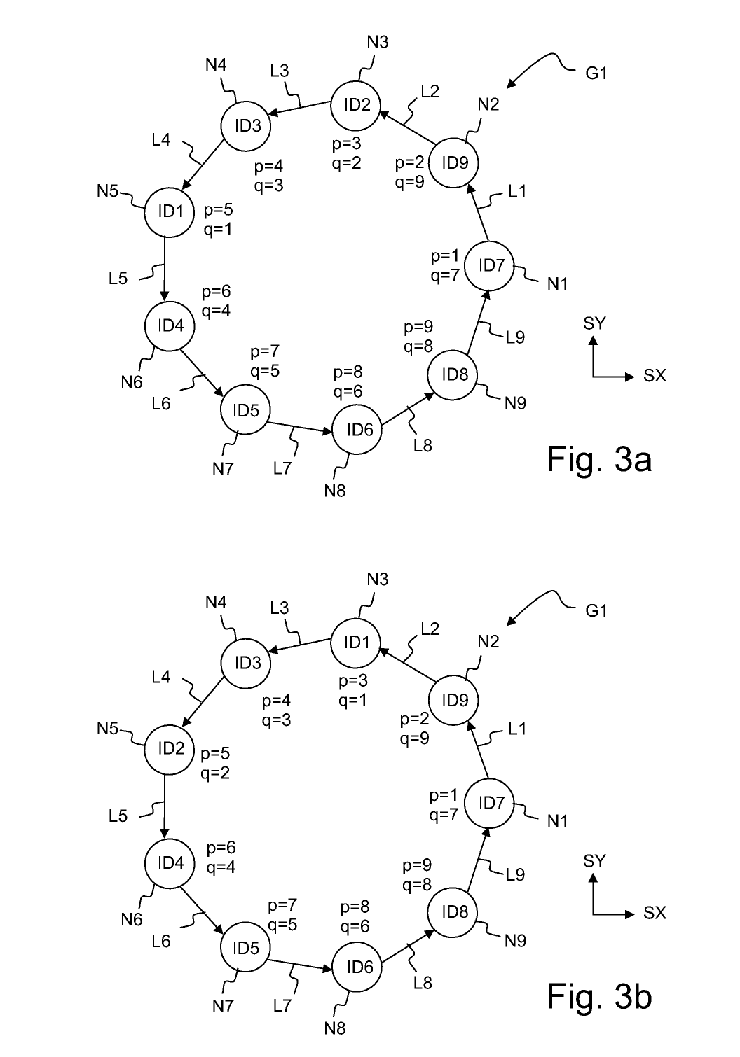

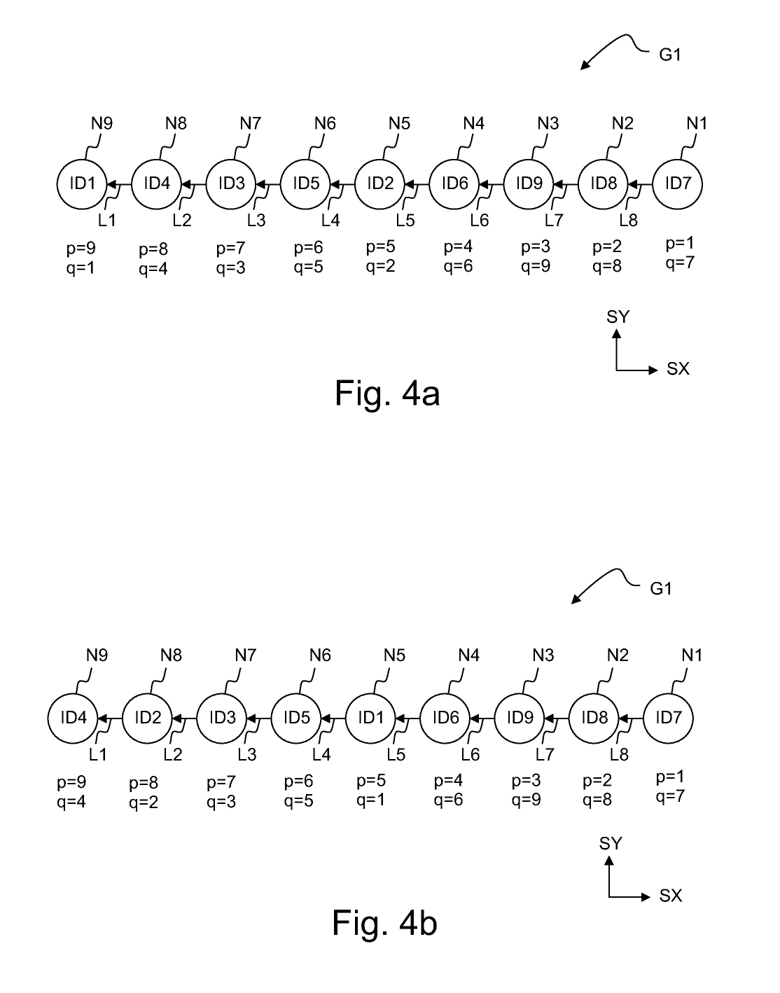

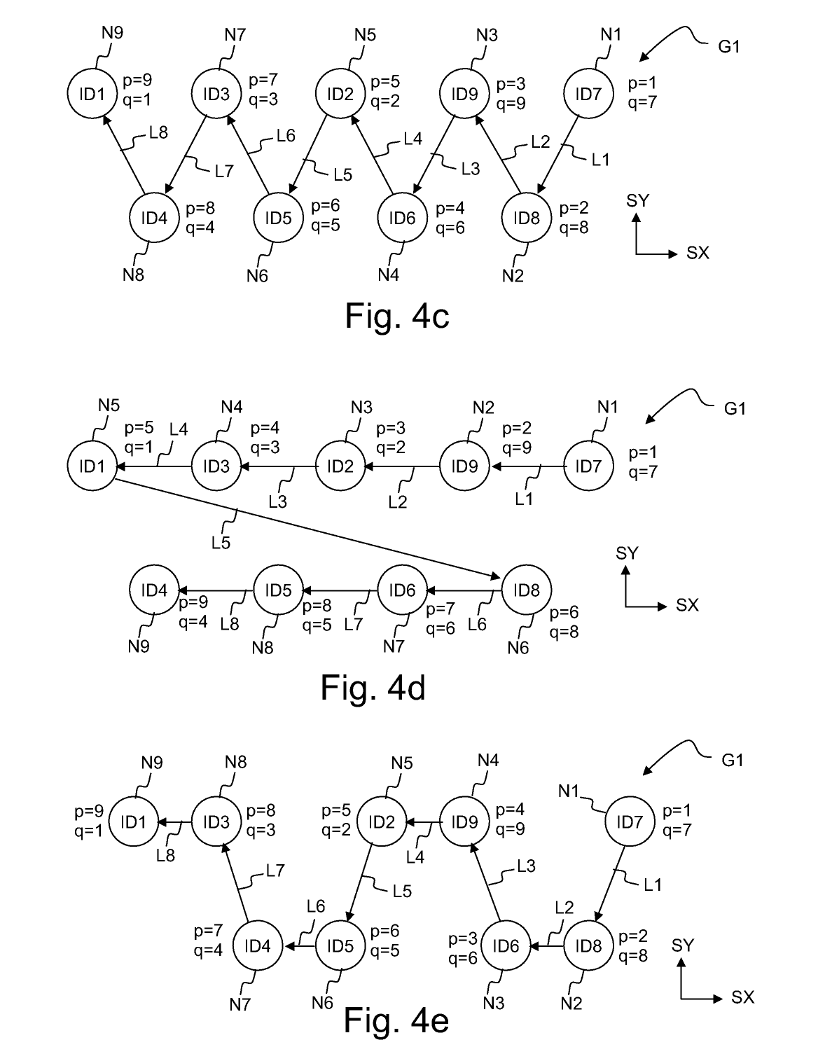

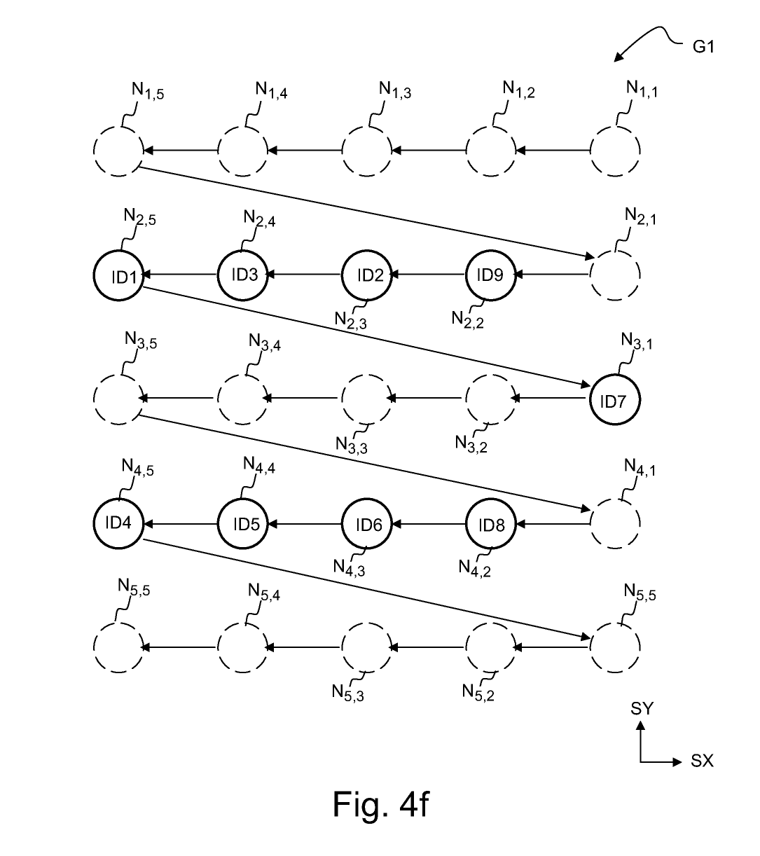

Referring to FIGS. 3a to 4b, a control sequence SEQ1 may be specified by a graph G1. The graph G1 may comprise e.g. three or more nodes N1, N2, . . . N9 connected by links L1, L2, . . . L9. Each node of the graph G1 may be associated with a different identification code ID1, ID2, . . . ID9. When a first node N1 and second node N2 are connected by a link L1, this may represent a situation where the identifiers associated with the first node N1 and the second node N2 are adjacent in the control sequence SEQ1. The graph G1 may also be called e.g. as control graph. A graph G1 may comprise adjacent nodes Nₚ₋₁, Nₚ, Nₚ₊₁ such that the node Nₚ is located between the node Nₚ₋₁ and the node Nₚ₊₁. Np denotes a node at the position p in the graph G1. p indicates the position of the node Np in the graph G1. The integer m may indicate the number of the nodes Nₖ in the graph G1. q(p) indicates an identifier associated with the element Np at the position p. IDq(p) indicates an identification code IDq associated with the element Np at the position p.

Each node N1, N2, N3, . . . of the graph G1 may represent a different device. Each node N1, N2, N3, . . . of the graph G1 may contain an identifier. Each node may be connected to other nodes by links L1, L2, . . . Each node Nₚ₋₁, Nₚ, Nₚ₊₁ may represent a different device. The graph G1 may represent in a quantized manner the positions of the devices UNIT_{q}. Each node N1, N2, . . . N9 of the graph G1 may represent a different device e.g. according to an order determined by the sorted angular coordinates α_{q}. Each node of the graph G1 may be associated with a different identification code ID1, ID2, . . . .

The graph G1 may be e.g. circular (FIGS. 3a, 3b) or linear (FIGS. 4a, 4b). The group SET1 of FIG. 1a may be represented e.g. by the circular graph G1 shown in FIG. 3a or by the linear graph G1 shown in FIG. 4a. The group SET1 of FIG. 1b may be represented e.g. by the circular graph G1 shown in FIG. 3b or by the linear graph G1 shown in FIG. 4b. Nₘ is a parent node of the node N₁ when the graph G1 is a circular graph. Nₘ does not have a child node when the graph G1 is a linear graph. N₁ does not have a parent node when the graph G1 is a linear graph. A circular graph may also be called e.g. as ring. The number of nodes of the graph G1 may be smaller than or equal to the number of the devices of the group SET1. In particular, the number of nodes of the graph G1 may be equal to the number m of the devices of the group SET1.

Referring to FIGS. 4c-4e, different graphs G1 may be formed based on the positions of the devices UNIT_{q}. Depending on the application, different graphs G1 may be formed even from the same spatial arrangement of the devices UNIT_{q}. For example, the graphs G1 shown in FIGS. 4c-4e may be interpreted to correspond to the spatial arrangement of the devices shown in FIG. 1a. The graphs G1 may define different control sequences. The graph of FIG. 4c may define e.g. a control sequence [7,8,9,6,2,5,3,4,1]. The graph of FIG. 4d may define e.g. a control sequence [7,9,2,3,1,8,6,5,4,]. The graph of FIG. 4e may define e.g. a control sequence [7,8,6,9,2,5,4,3,1].

FIGS. 2a and 2b illustrated checking whether the spatial positions of the devices UNIT_{q} substantially match with an elliptical or linear reference pattern. Depending on the application, the spatial positions may also be compared with one or more other reference patterns. Depending on the application, the spatial positions may be compared e.g. with a star pattern, in order to determine the nodes of a star graph. Depending on the application, the spatial positions may be compared e.g. with the sites of a two-dimensional rectangular grid, in order to determine the nodes of a two-dimensional grid graph. The control sequence may be determined e.g. by topologically sorting the nodes of the graph. For example, the grid graph G1 of FIG. 4f may be determined from the spatial positions of FIG. 1a. The grid graph G1 may comprise nodes N_{1,1}, N_{1,2}, . . . N_{5,5} arranged in several rows. For example, a control sequence [0,0,0,0,0,0,9,2,3,1,7,0,0,0,0,0,8,6,5,4,0,0,0,0,0] may be formed from the graph of FIG. 4e. Each term of the sequence may be associated with a predetermined task. Each non-zero term of the sequence may be associated with a predetermined task. Each zero-valued identifier of the sequence may be associated with an empty task or a delay of predetermined duration. Each non-zero identifier may be associated with a task identified by said identifier. For example, the identifier q=9 may be associated with a task TASK₉.

Depending on the application, the spatial positions may be compared e.g. with the sites of a three-dimensional grid, in order to determine the nodes of a three-dimensional grid graph.

Each node Np of a graph G1 at the position p may be associated with a task TASK_{q(p)}. TASK_{q(p)} may denote a task associated with the node Np.

In an embodiment, the graph G1 may be directed graph, which comprises nodes Np and directed links Lp. The nodes Np may also be called e.g. as vertices. The directed links Lp may also be called e.g. as directed edges.

When a first node N1 is connected to a second node N2 by a directed link L1, this may mean that a task (e.g. TASK₉) associated with the second node N2 can be performed only after a task (e.g. TASK₇) associated with the first node has been started (or finished).

TASK_{q(p)} may denote a task, which is started at a time tₚ, and which is finished at a time t′ₚ. The task TASK_{q(p)} refers to the task, which is associated with the identifier q, and which is associated with the position p of the control sequence SEQ1. The task TASK_{q(p)} may be performed by using the device UNIT_{q}. For example, the unit UNIT₁ may be configured to perform a task TASK₁, the unit UNIT₂ may be configured to perform a task TASK₂, the unit UNIT₅ may be configured to perform a task TASK₃, . . . , and the unit UNITₘ may be configured to perform a task TASKₘ.

TASK_{q(p+1)} may denote a task, which is started at a time tₚ₊₁, and which is finished at a time t′ₚ₊₁. The task TASK_{q(p+1)} may be started after the previous task TASK_{q(p)} has been started (i.e. tₚ₊₁>tₚ). TASK_{q(p-1)} may denote a task, which is started at a time tₚ₋₁, and which is finished at a time t′ₚ₋₁.

The tasks TASK_{q(p-1)}, TASK_{q(p)}, TASK_{q(p+1)}, . . . may comprise e.g. receiving user input

The tasks TASK_{q(p-1)}, TASK_{q(p)}, TASK_{q(p+1)}, . . . may comprise e.g. providing a visual signal and/or displaying information.

The tasks TASK_{q(p-1)}, TASK_{q(p)}, TASK_{q(p+1)}, . . . may comprise e.g. changing the state of the system 1000 according to user input

For example, a first task (TASK_{q(p)}) may comprise obtaining user input by a first device (UNIT_{q(p)}), a second task (TASK_{q(p+1)}) may comprise obtaining user input by a second device (UNIT_{q(p+1)}), a third task (TASK_{q(p+2)}) may comprise obtaining user input by a third device (UNIT_{q(p+2)}), the second task (TASK_{q(p+1)}) may be performed after the first task (TASK_{q(p)}) has been finished, and the third task (TASK_{q(p+2)}) may be performed after the second task (TASK_{q(p+1)}) has been finished.

For example, a first task (TASK_{q(p)}) may comprise displaying information by a first device (UNIT_{q(p)}), a second task (TASK_{q(p+1)}) may comprise displaying information by a second device (UNIT_{q(p+1)}), a third task (TASK_{q(p+2)}) may comprise displaying information by a third device (UNIT_{q(p+2)}), the second task (TASK_{q(p+1)}) may be performed after the first task (TASK_{q(p)}) has been finished, and the third task (TASK_{q(p+2)}) may be performed after the second task (TASK_{q(p+1)}) has been finished.

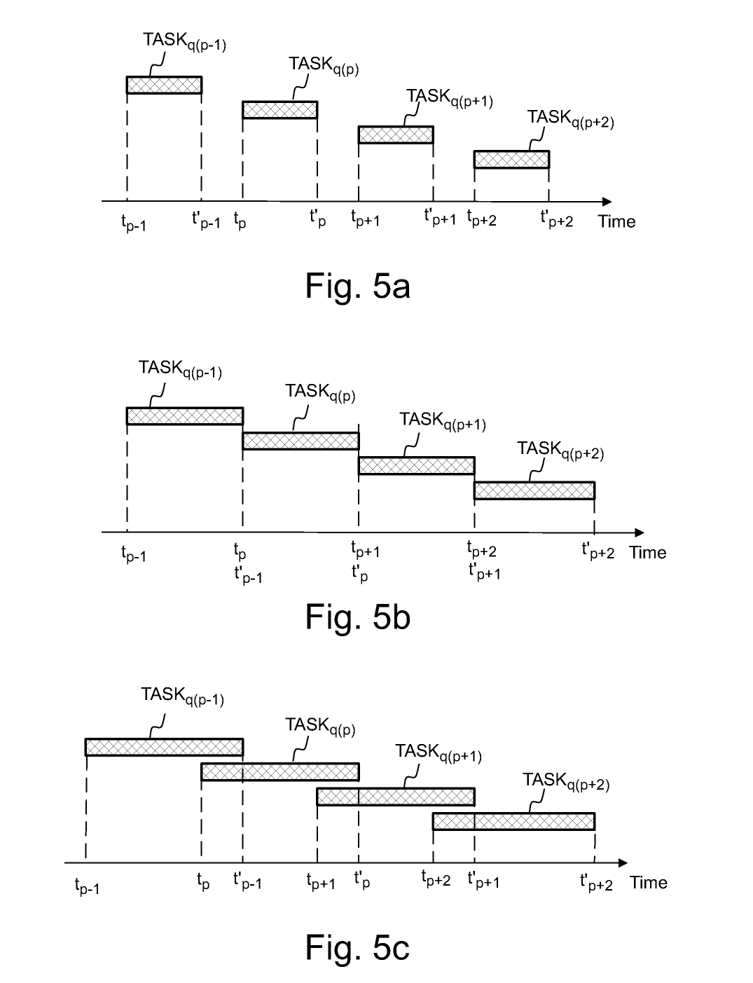

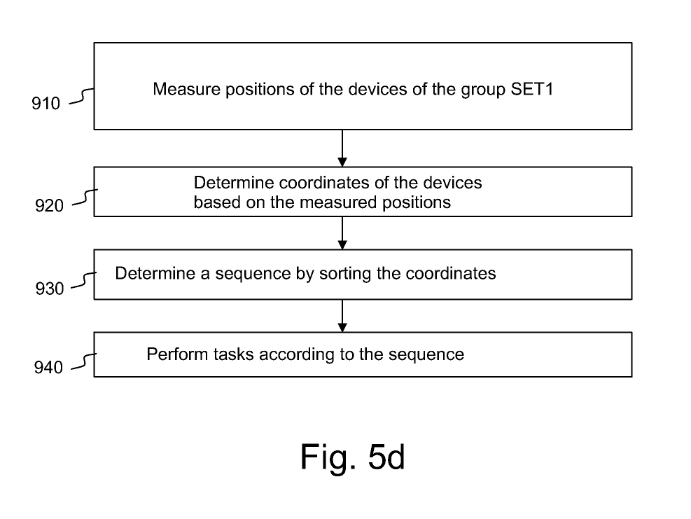

Referring to FIG. 5a, a task TASK_{q(p+1)} may be started after a previous task TASK_{q(p)} has been finished (i.e. tₚ₊₁>t′ₚ). The task TASK_{q(p)} may be started after a previous task TASK_{q(p-1)} has been started. The task TASK_{q(p)} may be started after a previous task TASK_{q(p-1)} has been finished. The task TASK_{q(p+1)} may be started after the task TASK_{q(p)} has been started. A task TASK_{q(p+2)} may be started after the task TASK_{q(p+1)} has been started. The task TASK_{q(p+2)} may be started after the task TASK_{q(p+1)} has been finished. The task TASK_{q(p-1)} may be started at the time tₚ₋₁, and the task TASK_{q(p-1)} may be finished at the time t′ₚ₋₁. The task TASK_{q(p)} may be started at the time tₚ, and the task TASK_{q(p)} may be finished at the time t′ₚ. The task TASK_{q(p+1)} may be started at the time tₚ₊₁, and the task TASK_{q(p+1)} may be finished at the time t′ₚ₊₁. The task TASK_{q(p+2)} may be started at the time tₚ₊₂, and the task TASK_{q(p+2)} may be finished at the time t′ₚ₊₂.

Referring to FIG. 5b, a task TASK_{q(p)} may be started substantially immediately when a previous task TASK_{q(p-1)} has been finished (i.e. tₚ=t′ₚ₋₁). A task TASK_{q(p+1)} may be started substantially immediately when the previous task TASK_{q(p)} has been finished (i.e. tₚ₊₁=t′ₚ). A task TASK_{q(p+2)} may be started substantially immediately when the previous task TASK_{q(p+1)} has been finished (i.e. (i.e. tₚ₊₂=t′ₚ₊₁). The task TASK_{q(p-1)} may be started at the time tₚ₋₁, and the task TASK_{q(p-1)} may be finished at the time t′ₚ₋₁. The task TASK_{q(p)} may be started at the time tₚ, and the task TASK_{q(p)} may be finished at the time t′ₚ. The task TASK_{q(p+1)} may be started at the time tₚ₊₁, and the task TASK_{q(p+1)} may be finished at the time t′ₚ₊₁. The task TASK_{q(p+2)} may be started at the time tₚ₊₂, and the task TASK_{q(p+2)} may be finished at the time t′ₚ₊₂.

Referring to FIG. 5c, a task TASK_{q(p)} may be started before the previous task TASK_{q(p-1)} has been finished (i.e. tₚ<t′ₚ₋₁). A task TASK_{q(p+1)} may be started before the previous task TASK_{q(p)} has been finished (i.e. tₚ₊₁<t′ₚ). A task TASK_{q(p+2)} may be started before the previous task TASK_{q(p+1)} has been finished (i.e. tₚ₊₂<t′ₚ₊₁). TASK_{q(p)} denotes a task, which is started after the task TASK_{q(p-1)} has been started (i.e. tₚ>tₚ₋₁). TASK_{q(p+1)} denotes a task, which is started after the task TASK_{q(p)} has been started (i.e. tₚ₊₁>tₚ). TASK_{q(p+2)} denotes a task, which is started after the task TASK_{q(p+1)} has been started (i.e. tₚ₊₂>tₚ₊₁). The task TASK_{q(p-1)} may be started at the time tₚ₋₁, and the task TASK_{q(p-1)} may be finished at the time t′ₚ₋₁. The task TASK_{q(p)} may be started at the time tₚ, and the task TASK_{q(p)} may be finished at the time t′ₚ. The task TASK_{q(p+1)} may be started at the time tₚ₊₁, and the task TASK_{q(p+1)} may be finished at the time t′ₚ₊₁. The task TASK_{q(p+2)} may be started at the time tₚ₊₂, and the task TASK_{q(p+2)} may be finished at the time t′ₚ₊₂.

The tasks may be ordered e.g. according to the raising order of the angular coordinates α₁, α₂, . . . , α₉.

The tasks may be ordered e.g. according to the raising order of the absolute values of the angular coordinates |α₁|, |α₂|, . . . , |α₉|.

The tasks may be ordered e.g. according to the raising order of the x-coordinates x₂, . . . x₉.

The tasks may be ordered e.g. according to the raising order of the y-coordinates y₁, y₂, . . . y₉.

The devices may be ordered e.g. according to the raising order of the angular coordinates α₁, α₂, . . . , α₉.

The devices may be ordered e.g. according to the raising order of the absolute values of the angular coordinates |α₁|, |α₂|, |α₉|.

The devices may be ordered e.g. according to the raising order of the x-coordinates x₁, x₂, . . . x₉.

The devices may be ordered e.g. according to the raising order of the y-coordinates y₁, y₂, . . . y₉.

A graph G1 may represent the quantized positions of the devices UNIT_{q} of the group SET1. The graph G1 may represent the control sequence SEQ1. Communication between the devices of the group SET1 may be controlled according to the graph G1. An order of providing information by the different devices may be controlled according to the graph G1.

The identifiers associated with the nodes of the graph G1 may be ordered e.g. according to the raising order of the angular coordinates α₁, α₂, . . . , α₉.

The identifiers q associated with the nodes of the graph G1 may be ordered e.g. according to the raising order of the absolute values of the angular coordinates |α₁|, |α₂|, . . . , |α₉|.

The identifiers q associated with the nodes of the graph G1 may be ordered e.g. according to the raising order of the coordinates x_{q}.

The identifiers q associated with the nodes of the graph G1 may be ordered e.g. according to the raising order of the coordinates y_{q}.

FIG. 5d shows method steps for controlling operation of the system 1000 and/or for controlling operation of a single device UNIT_{q}.

In step 910, the measured positions of the devices may be provided.

In step 920, the coordinates of the devices may be determined based on the measured positions.

In step 930, the control sequence SEQ1 may be provided e.g. by sorting the coordinates and/or by minimizing the sum of the pairwise distances.

In step 940, the operation of the system 1000 and/or the operation of a single device UNIT_{q} may be controlled based on the control sequence SEQ1.

The operation of the system 1000 and/or the operation of a single device UNIT_{q} may be controlled based on the control sequence SEQ1 and based on a previous task

TASK_{q(p-1)}. Performing a task TASK_{q(p)} may be controlled based on the control sequence SEQ1 and based on a previous task TASK_{q(p)}).

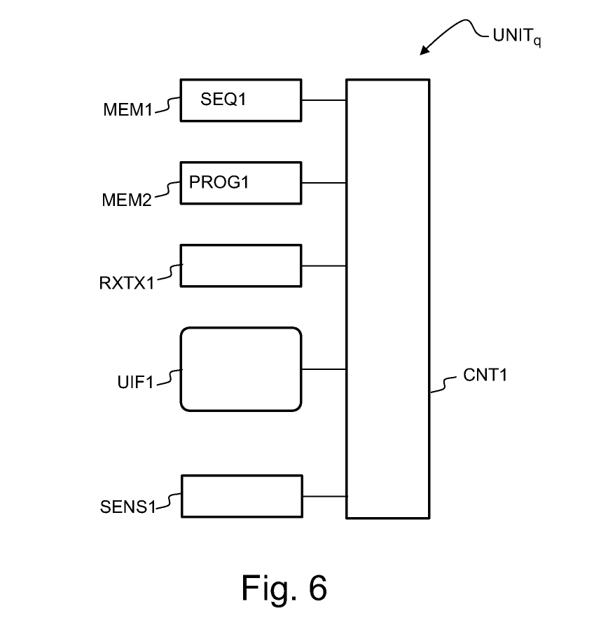

FIG. 6 shows functional units of a device UNIT_{q}, which may be used as a part of the group SET1. The device UNIT_{q} may comprise one or more processors CNT1, which may be configured to determine the position (x_{q},y_{q}) of one or more devices of the group G1. The device UNIT_{q} may comprise one or more processors CNT1, which may be configured to provide a control sequence SEQ1 based on the positions of the devices of the group G1. The device UNIT_{q} may comprise one or more processors CNT1, which may be configured to control operation of the device UNIT_{q} and/or to control operation of the system 1000 based on the positions of the devices of the group G1. The device UNIT_{q} may comprise a tracking device SENS1 for measuring the position (x_{q},y_{q}) of one or more devices of the group G1. The tracking device SENS1 may comprise e.g. an antenna, a microphone and/or an optical sensor. The device may comprise a user interface UIF1 for providing commands and/or for making selections. The device UNIT_{q} may comprise a user interface UIF1 for receiving user input and/or for displaying information. The device may comprise a communication unit RXTX1 for communicating data with one or more other devices of the system 1000.

The position x_{q},y_{q} of the devices UNIT_{q} may be measured e.g. optically. The position x_{q},y_{q} may be determined e.g. by analyzing images captured by an image sensor. The position x_{q},y_{q} of the devices UNIT_{q} may be measured e.g. based on propagation of radio waves. The position x_{q},y_{q} of the devices UNIT_{q} may be measured e.g. by analyzing sounds SW1, SW2 emitted from several locations.

A computer program PROG1 comprising computer program code may be configured to, when executed on at least one processor CNT1, cause an apparatus UNIT_{q} or a system 1000 to:
obtain measured positions (x_{q},y_{q}) of devices (UNIT_{q}) of a group (SET1),
determine a sequence (SEQ1) based on the measured positions (x_{q},y_{q}), and
control operation of one or more devices (UNIT_{q}) of a group (SET1) based on said sequence (SEQ1).

The device UNIT_{q} may comprise a memory MEM2 for storing the computer program PROG1. The device UNIT_{q} may optionally comprise a memory MEM1 for storing data, which specifies the control sequence SEQ1. Two or more devices UNIT_{q} may be configured to together store data, which specifies the control sequence SEQ1.

In an embodiment, the control sequence SEQ1 may be stored in a distributed manner. For example, it may be sufficient if each device UNIT_{q} having an identifier q stores its own order number p(q). For example, a device UNIT_{q} having an order number p(q) may be configured to change the state of the system 1000 only after an enabling signal has been received from another device, which has an order number p(q)−1.

One or more of other devices of the group SET1 may be substantially similar to the device UNIT_{q} shown in FIG. 6.

The devices UNIT_{q} may be manufactured and/or supplied as individual items, but they may be subsequently used as a part of the communication system 1000.

A group SET1 of the devices UNIT_{q} may be configured to provide e.g. a platform for playing a game. A group SET1 of the devices UNIT_{q} may be configured to provide e.g. a platform for gathering messages (e.g. “comments” or “feedback”) from the users in an order defined by the spatial positions of the devices.

For example one device of said group SET1 may be configured to initiate a data communicating session. Said initiating device may also operate as a master device. The master device may operate as server device for the session. Other devices may join the group SET1 by using wireless communication (e.g. NFC, WLAN, 3G).

The other devices of the group SET1 may transmit position signal data to the master device. The master device may be configured to determine the relative positions of the devices e.g. by analyzing the sounds received by microphones. Said analyzing may comprise analyzing the audio signals transmitted to the master device.

The master device may be configured to control operation of the system 1000 based on the control sequence SEQ1, wherein the control sequence SEQ1 may be determined based on the relative positions of the devices. The master device may be configured to control operation of the system 1000 based on a graph G1, which represents a control sequence SEQ1.

For example, the master device may be configured to execute commands provided by the different devices in an order determined by the control sequence SEQ1.

For example, the master device may be configured to allow making selections in an order determined by the control sequence SEQ1.

The control sequence SEQ1 may be optionally updated during a session according to the relative positions of the devices. Alternatively, the same control sequence SEQ1 may be applied throughout the session even if the relative positions of the devices would be changed.

The session may be e.g. a game like “Wheel of fortune”, “Roulette”, “spin the bottle” or “truth or dare”. For example, a user may swipe the touchscreen of his device. The device may be configured to display a visual element, e.g. a picture, video, animation of a bottle, a ball, or whatever is suitable for the session. The same visual element may then be shown sequentially in all devices of the group SET1 in the order determined by the sequence SEQ1 until the element stays in one randomly selected device. The device where the element stays may be assigned to have a different status when compared with the other devices. The device may be assigned to be e.g. a “loser” or a “winner”.

In an embodiment, the devices of the group SET1 may be configured to form a large display, where the individual devices may operate as pixels of the large display. For example, the devices of the group SET1 may be configured to create a “wave” in a football stadium by flashing the lights of people's mobile devices around the stadium. For example, the display of a device UNIT_{q} may be arranged to provide flashed light such that the color of the flashed light is determined based on the position index p(q) assigned for said device UNIT_{q}.

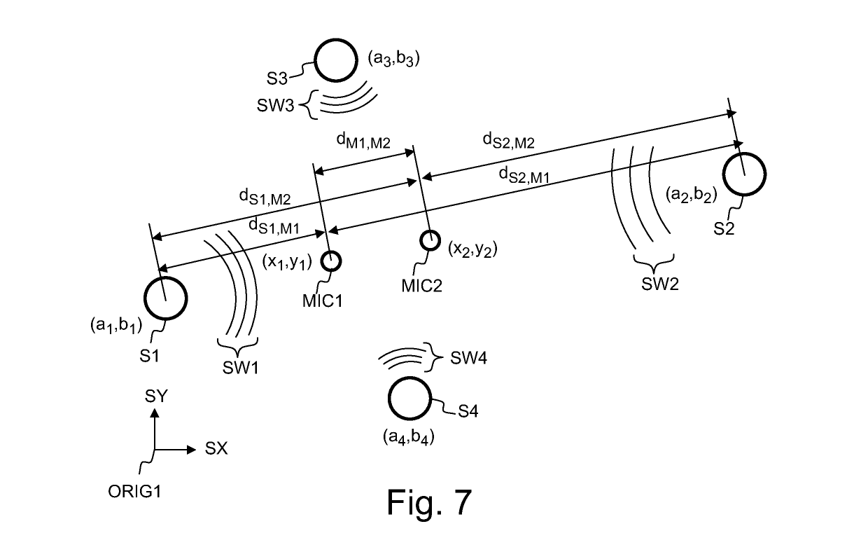

Referring to FIG. 7, the positions of the devices may be measured e.g. by analyzing sounds emitted from two or more sound sources S1, S2, S3, S4.

Each device may comprise one or more microphones MIC1, MIC2 for receiving sounds SW1, SW2, SW3, SW4. The sounds SW1, SW2, SW3, SW4 may be transient sounds, or at least they may have a transient component.

A first microphone MIC1 may be located at a first position (x₁,y₁), a second microphone MIC2 may be located at a second position (x₂,y₂), a first sound source S1 may be located at a first source position (a₁,b₁), a second sound source S2 may be located at a second source position (a₂,b₂). The first source S1 may emit a sound SW1. The second source S2 may emit a sound SW2. d_{S1,M1} denotes the distance from the first source S1 to the first microphone MIC1. d_{S1,M2} denotes the distance from the first source S1 to the second microphone MIC2. d_{S2,M1} denotes the distance from the second source S2 to the first microphone MIC1. d_{S2,M2} denotes the distance from the second source S2 to the second microphone MIC2. d_{M1,M2} denotes the distance between the microphones MIC1, MIC2. The distance d_{M1,M2} may also be called e.g. a pairwise distance.

The first microphone MIC1 may detect the sound SW1 at a time t_{S1,M1}. The first microphone MIC1 may detect the sound SW2 at a time t_{S2,M1}. The first microphone MIC2 may detect the sound SW1 at a time t_{S1,M2}. The second microphone MIC2 may detect the sound SW2 at a time t_{S2,M2}.

In an embodiment, the microphones MIC1,MIC2 may be located between the points (a₁,b₁), (a₂,b₂) such that the microphones MIC1,MIC2 are located on a line defined by the points (a₁,b₁), (a₂,b₂). A first sound source S1 and a second sound source S2 may be located on a line defined by the points (x₁,y₁), (x₂,y₂).

In this case, the distance d_{M1,M2} may be determined e.g. by measuring a time difference (t_{S1,M2}−t_{S1,M1}), and by multiplying said time difference with the speed of sound vₛ

d_{M1,M2}=(t_{S1,M2}−t_{S1,M1})vₛ (1a)

The distance d_{M1,M2} may also be determined e.g. by measuring a time difference (t_{S2,M1}−t_{S2,M2}), and by multiplying said time difference with the speed of sound vₛ

d_{M1,M2}=(t_{S2,M1}−t_{S2,M2})vₛ (1b)

The time t_{S1M1} may be detected by using a first clock CLK1, and the time t_{S1,M2} may be detected by using a second clock CLK2. The time difference (t_{S1,M2}−t_{S1M1}) may be measured accurately when the second clock CLK2 is accurately synchronized with the first clock CLK1. However, accurate synchronization of the clocks CLK1, CLK2 may sometimes be difficult.

Audio signals received by the microphones MIC1, MIC2 may be communicated to a common data processing unit in order to avoid the need for accurately synchronizing the clocks CLK1, CLK2.

A first auxiliary time difference Δt_{AUX1} may be determined by analyzing the sounds SW1, SW2 received by the first microphone MIC1.

Δt_{AUX1}=t_{S2,M1}−t_{S1,M1} (2c)

A second auxiliary time difference Δt_{AUX2} may be determined by analyzing the sounds SW1, SW2 received by the second microphone MIC2.

Δt_{AUX2}=t_{S1,M2}−t_{S2,M2} (2d)

The distance d_{M1,M2} may also be determined by using the first auxiliary time difference Δt_{AUX1} and the second auxiliary time difference Δt_{AUX2}:

$${d}_{M 1 , M 2} = \frac{( Δ {t}_{AUX 1} + Δ {t}_{AUX 2} ) {v}_{s}}{2} \qquad ( 2 e )$$

When using equation (2e) the clocks CLK1, CLK2 do not need to be synchronized with respect to each other.

Equation (2e) may provide an accurate distance when the sound sources are on the line defined by the positions of the microphones MIC1, MIC2. However, a maximum distance value determined by the equation (2e) may be used as an estimate for the distance d_{M1,M2} also when analyzing sounds from sources, which are not on the line defined by the positions of the microphones MIC1, MIC2. The accuracy of the estimate may be improved (at least in the statistical sense) by increasing the number of the sound sources. In an embodiment, the locations of the sound sources S1, S2 may be varied in order to improve the accuracy of the estimate for the pairwise distance d_{M1,M2}.

The pairwise distance for each microphone pair of the system may be estimated in the corresponding manner, by analyzing sounds emitted from two or more sound sources. Once the pairwise distances have been determined, the relative position of each microphone of the system may be determined with respect to the other microphones. The relative position of each microphone of the system may be determined from the pairwise distances.

In an embodiment, the first auxiliary time difference Δt_{AUX1} may be determined near the first microphone MIC1, the second auxiliary time difference Δt_{AUX2} may be determined near the second microphone MIC2, and the value Δt_{AUX1} and/or Δt_{AUX2} may be transmitted so that they are available for calculating the pairwise distance according to equation (2e). In other words, it is not necessary to transmit audio signals. However, determining the pairwise distance e.g. in a noisy environment may be facilitated by transmitting the audio signals to be analyzed by a common data processing unit. This may facilitate determining the pairwise distance when several sound sources are emitting sounds simultaneously.

The (relative) positions of the devices may be determined by:
receiving a first sound at a first receiving location and at a second receiving location,
receiving a second sound at the first receiving location and at the second receiving location,
determining the relative position of the second receiving location with respect to the first receiving location by analyzing the sounds received at the first receiving location and at a second receiving location.

The method may further comprise:
receiving the first sound and the second sound at a third receiving location, and
determining the relative position of the third receiving location by analyzing the sounds received at the third receiving location.

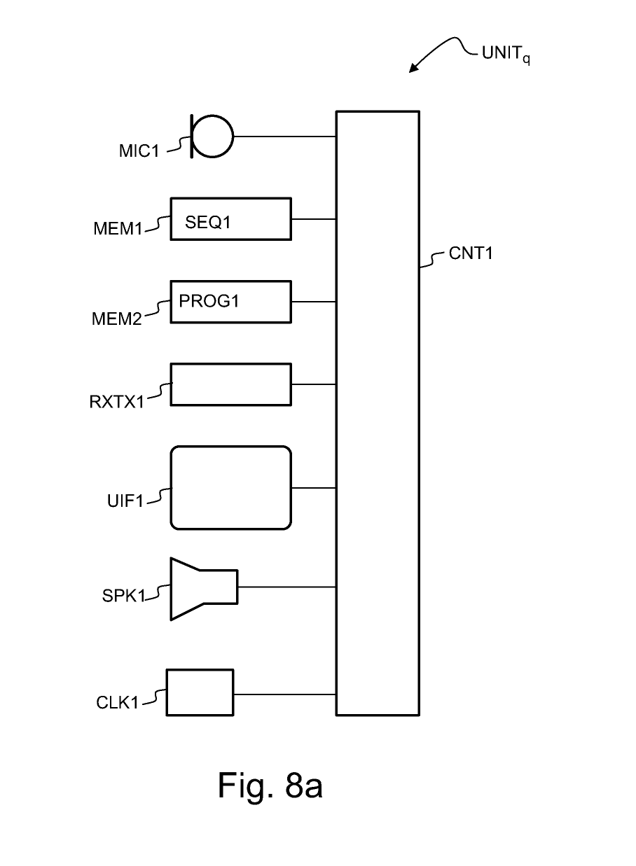

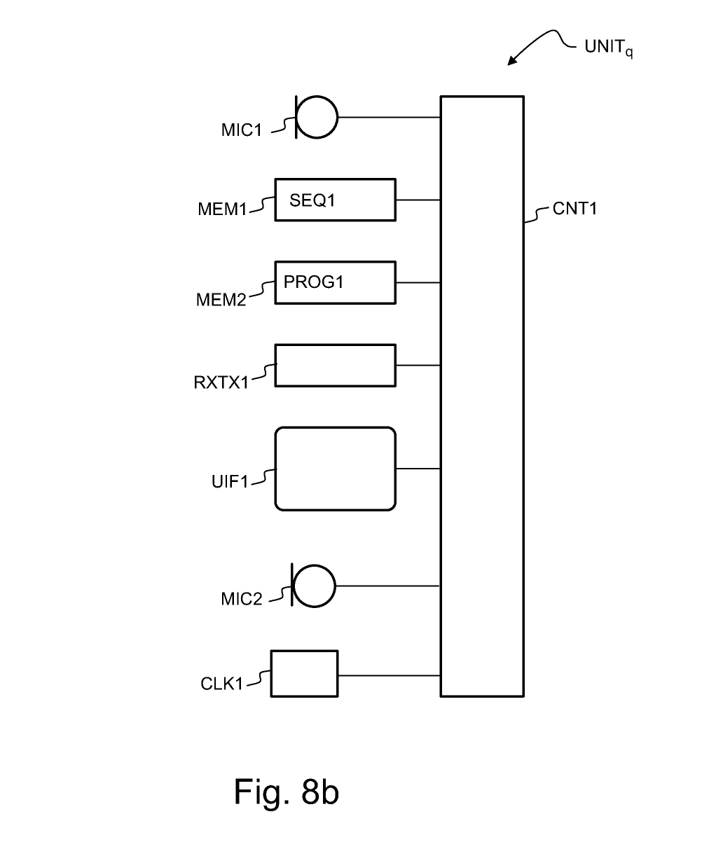

Referring to FIG. 8a, a device UNIT_{q} may be configured to determine the position of one or more devices of the group SET1 by analyzing sounds SW1, SW2 received from two or more sound sources S1, S2. The device UNIT_{q} may comprise one or more microphones MIC1 for receiving the sounds SW1, SW2.

The device UNIT_{q} may comprise one or more processors CNT1, which may be configured to determine the position (x_{q},y_{q}) of one or more devices of the group G1 by analyzing the sounds. The device UNIT_{q} may comprise one or more processors CNT1, which may be configured to provide a control sequence SEQ1 based on the positions of the devices of the group G1. The device UNIT_{q} may comprise one or more processors CNT1, which may be configured to control operation of the device UNIT_{q} and/or to control operation of the system 1000 based on the positions of the devices of the group G1. The device may comprise a user interface UIF1 for providing commands and/or for making selections. The device UNITq may comprise a user interface UIF1 for receiving user input and/or for displaying information. The device may comprise a communication unit RXTX1 for communicating data with one or more other devices of the system 1000.

A computer program PROG1 comprising computer program code may be configured to, when executed on at least one processor CNT1, cause an apparatus UNIT_{q} or a system 1000 to:
obtain measured positions (x_{q},y_{q}) of devices (UNIT_{q}) of a group (SET1),
determine a sequence (SEQ1) based on the measured positions (x_{q},y_{q}), and
control operation of one or more devices (UNIT_{q}) of a group (SET1) based on said sequence (SEQ1).

A computer program PROG1 comprising computer program code may be configured to, when executed on at least one processor CNT1, cause an apparatus UNIT_{q} or a system 1000 to determine the relative position of a second receiving location with respect to a first receiving location by analyzing the sounds received at the first receiving location and at a second receiving location.

The analysis of the sounds may be executed by using a computer program PROG1 stored in the memory MEM2. The communication unit RXTX1 may optionally transmit audio signals to be analyzed by a master device. The device of FIG. 8a may be configured to operate as a master device, wherein the communication unit RXTX1 may be configured to receive audio signals from the other devices of the group SET1. The audio signals may be used for determining the auxiliary time differences Δt_{AUX1}, Δt_{AUX2}

The device UNIT_{q} may optionally comprise a speaker SPK1 for reproducing sounds. The device UNIT_{q} may optionally comprise a speaker SPK1 for emitting sounds.

Referring to FIG. 8b, the device UNIT_{q} may further comprise a second microphone MIC2 in addition to the first microphone MIC1. In an embodiment, the orientation of the device may be determined by analyzing sounds received by the first microphone MIC1 and by the second microphone MIC2. The device may comprise one or more processors CNT1, which may be configured to analyze the sounds received by the microphones MIC1, MIC2. The device may comprise one or more processors CNT1, which may be configured to determine the relative position of the device UNITq by analyzing the sounds received by the microphones MIC1, MIC2.

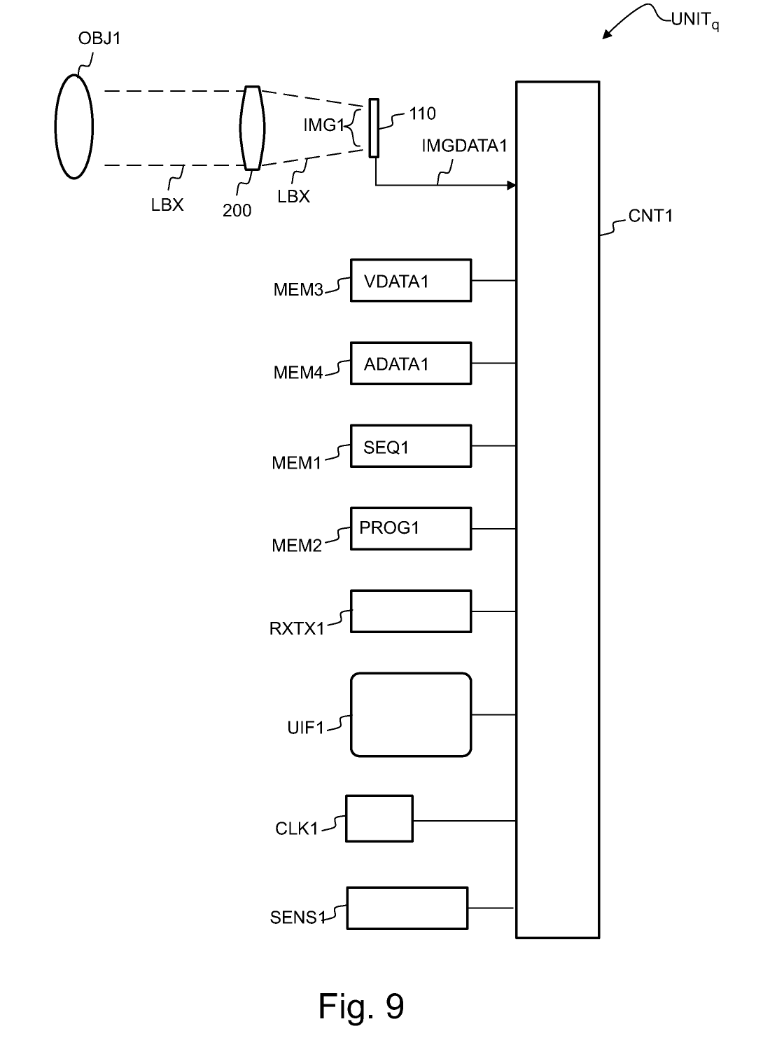

Referring to FIG. 9, the device may further comprise an image sensor 110 and imaging optics 200, which may be arranged to form an image of an object OBJ1 on an image sensor 110. The imaging optics 200 may focus light LBX to the image sensor 110. The image sensor 110 may be configured to provide image data IMGDATA1. The image sensor 110 may be configured to capture a video sequence VDATA1. The device may optionally comprise a memory MEM3 for storing the video sequence VDATA1. The device UNITq may optionally comprise a memory MEM4 for storing an audio signal ADATA1 captured by one or more microphones MIC1, MIC2. In an embodiment, the audio data ADATA1 may be combined with the video data VDATA1, and the audio data ADATA1 and the video data VDATA1 may be stored in the same memory MEM3. The device may be a video camera, which comprises a stereo microphone.

FIG. 10a shows, by way of example, a communication system 1000. The system 1000 may comprise a plurality of devices UNIT_{q}, which are arranged to communicate with each other and/or with a server 1240. The devices UNIT_{q} may be portable. One or more devices UNITq may comprise a user interface UIF1 for receiving user input. One or more devices UNIT_{q} may comprise a user interface UIF1 for making a selection. One or more devices UNIT_{q} and/or a server 1240 may comprise one or more data processors configured to control communication according to the control sequence SEQ1.

The system 1000 may comprise end-user devices such as one or more portable devices UNIT_{q}, mobile phones or smart phones 1251, Internet access devices (Internet tablets), personal computers 1260, a display or an image projector 1261 (e.g. a television), and/or a video player 1262. One or more of the devices UNIT_{q} may comprise an image sensor 110 for capturing image data. A server, a mobile phone, a smart phone, an Internet access device, or a personal computer may be arranged to distribute data according to the spatial positions of the devices UNIT_{q}. Distribution and/or storing data may be implemented in the network service framework with one or more servers 1240, 1241, 1242 and one or more user devices. As shown in the example of FIG. 10a, the different devices of the system 1000 may be connected via a fixed network 1210 such as the Internet or a local area network (LAN). The devices may be connected via a mobile communication network 1220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks may be connected to each other by means of a communication interface 1280. A network (1210 and/or 1220) may comprise network elements such as routers and switches to handle data (not shown). A network may comprise communication interfaces such as one or more base stations 1230 and 1231 to provide access for the different devices to the network. The base stations 1230, 1231 may themselves be connected to the mobile communications network 1220 via a fixed connection 1276 and/or via a wireless connection 1277. There may be a number of servers connected to the network. For example, a server 1240 for providing a network service such as a social media service may be connected to the network 1210. A second server 1241 for providing a network service may be connected to the network 1210. A server 1242 for providing a network service may be connected to the mobile communications network 1220. Some of the above devices, for example the servers 1240, 1241, 1242 may be arranged such that they make up the Internet with the communication elements residing in the network 1210. The devices UNITq, 1251, 1260, 1261, 1262 can also be made of multiple parts. One or more devices may be connected to the networks 1210, 1220 via a wireless connection 1273. Communication COM2 between a device UNIT_{q} and a second device of the system 1000 may be fixed and/or wireless. Communication COM1 between the devices UNIT_{q} may be wireless. One or more devices may be connected to the networks 1210, 1220 via communication connections such as a fixed connection 1270, 1271, 1272 and 1280. One or more devices may be connected to the Internet via a wireless connection 1273. One or more devices may be connected to the mobile network 1220 via a fixed connection 1275. A device UNIT_{q}, 1251 may be connected to the mobile network 1220 via a wireless connection COM1, 1279 and/or 1282. The connections 1271 to 1282 may be implemented by means of communication interfaces at the respective ends of the communication connection. A user device UNIT_{q}, 1251 or 1260 may also act as web service server, just like the various network devices 1240, 1241 and 1242. The functions of this web service server may be distributed across multiple devices. Application elements and libraries may be implemented as software components residing on one device. Alternatively, the software components may be distributed across several devices. The software components may be distributed across several devices so as to form a cloud.

FIG. 10b shows a portable device UNIT_{q}, which may be used as a part of the communication system 1000. The device UNIT_{q} may be e.g. a mobile phone, a smartphone, a communicator, a portable computer, a camera, or a personal digital assistant (PDA). The device UNIT_{q} may comprise a tracking unit SENS1 for providing data, which enables determining the position of the device UNIT_{q}. The device UNIT_{q} may comprise a communication unit RXTX1 for communicating with one or more other devices of a communication system 1000. The device UNIT_{q} may comprise a processor CNT1 e.g. for controlling operation of the device UNIT_{q} and/or the system 1000. The device UNIT_{q} may comprise a memory MEM2 for storing a computer program PROG1. The device UNIT_{q} may optionally comprise a user interface UIF1 for displaying information and/or for receiving user input from a user. The device UNIT_{q} may optionally comprise an image sensor 110 providing image data IMGDATA1. The device UNIT_{q} may optionally comprise a memory MEM3 for storing the image data IMGDATA1. A microphone MIC1, MIC2 may be optionally used e.g. to implement a mobile phone functionality. Sounds received by one or more microphone MIC1, MIC2 may be optionally analyzed in order to determine the positions of one or more devices.

FIG. 10c shows a server 1240, which may comprise a memory 1245, one or more processors (PROC) 1246, 1247, and computer program code 1248 (PROGRAM) residing in the memory 1245 for implementing, for example, a service for playing a game.

For the person skilled in the art, it will be clear that modifications and variations of the devices and the methods according to the present invention are perceivable. The figures are schematic. The particular embodiments described above with reference to the accompanying drawings are illustrative only and not meant to limit the scope of the invention, which is defined by the appended claims.

1-65. (canceled)

66. A method comprising:
measuring positions of devices of a group,
determining a sequence based on the measured positions, and
controlling operation of one or more devices of a group based on said sequence.

67. The method of claim 66 comprising determining the type of said sequence based on the measured positions of the devices.

68. The method of claim 66 comprising determining the type of said sequence based on the distances of the devices from a reference curve.

69. The method according to the claim 66 wherein said sequence is determined based on a sum of distances or projected distances between pairs of devices, wherein said pairs are formed such that the first device and the second device of each pair correspond to adjacent elements of said sequence.

70. The method according to the claim 66 comprising:
determining one or more coordinates for each device of said group based on the measured positions, and
determining the sequence by sorting said coordinates.

71. The method of claim 70 wherein said coordinates are angular coordinates, and said sequence is a cyclic sequence.

72. The method according to the claim 66, wherein the positions of the devices are measured based on propagation of radio waves, or sound waves.

73. An apparatus comprising at least one processor, a memory including computer program code, the memory and the computer program code configured to, with the at least one processor, cause the apparatus to perform at least the following:
obtain positions of devices of a group,
determine a sequence based on the obtained positions, and
control operation of one or more devices of a group based on said sequence.

74. The apparatus of claim 73 configured to determine the type of said sequence based on the measured positions of the devices.

75. The apparatus of claim 73 configured to determine the type of said sequence based on the distances of the devices from a reference curve.

76. The apparatus according to the claim 73 configured to determine said sequence based on a sum of distances or projected distances between pairs of devices, wherein said pairs are formed such that the first device and the second device of each pair correspond to adjacent elements of said sequence.

77. The apparatus according to the claim 73 configured to:
determine one or more coordinates for each device of said group based on the measured positions, and
determine the sequence by sorting said coordinates.

78. The apparatus of claim 77 wherein said coordinates are angular coordinates, and said sequence is a cyclic sequence.

79. The apparatus according to the claim 73, wherein the positions of the devices are measured based on propagation of radio waves or sound waves.

80. A computer program comprising computer program code configured to, when executed on at least one processor, cause an apparatus or a system to:
measure positions of devices of a group,
determine a sequence based on the measured positions, and
control operation of one or more devices of a group based on said sequence.

81. The computer program of claim 80, wherein the type of said sequence is determined based on the measured positions of the devices.

82. The computer program of claim 80, wherein the type of said sequence is determined based on the distances of the devices from a reference curve.

83. The computer program according to the claim 80, wherein said sequence is determined based on a sum of distances or projected distances between pairs of devices, wherein said pairs are formed such that the first device and the second device of each pair correspond to adjacent elements of said sequence.

84. The computer program according to the claim 80, configured to cause an apparatus or a system to:
determine one or more coordinates for each device of said group based on the measured positions, and
determine the sequence by sorting said coordinates.

85. The computer program of claim 84 wherein said coordinates are angular coordinates, and said sequence is a cyclic sequence.

86. The computer program according to the claim 80, wherein the positions of the devices are measured based on propagation of radio waves or sound waves.
